(19) United States
(12) Patent Application Publication
(10) Pub. No.: US 2011/0258670 A1
(43) Pub. Date: Oct. 20, 2011

(54) METHOD AND APPARATUS FOR VIDEO TRANSMISSION IN COMMUNICATION SYSTEM FOR SUPPORTING INTERNET PROTOCOL TELEVISION SERVICE BETWEEN HETEROGENEOUS NETWORKS

(75) Inventors: Kyung-Wook Baek, Daedeok-gu (KR); Jin-Woo Jeon, Suwon-si (KR); Young-Seop Han, Suseong-gu (KR); Young-Jip Kim, Suwon-si (KR); Hee-Yong Youn, Seongnam-si (KR); Kyung-Tae Kim, Suwon-si (KR)

(73) Assignees: SUNGKYUNKWAN UNIVERSITY FOUNDATION FOR CORPORATE COLLABORATION, Suwon-si (KR); SAMSUNG ELECTRONICS CO., LTD., Suwon-si (KR)

(21) Appl. No.: 13/089,139

(22) Filed: Apr. 18, 2011

(30) Foreign Application Priority Data
Apr. 20, 2010 (KR) 10-2010-0036400

(51) Int. Cl. H04N 7/173

(52) U.S. Cl. 725/87

(57) ABSTRACT

An apparatus and method provide effective video transmission in a communication system that supports an Internet Protocol Television (IPTV) service between heterogeneous networks. A request for a contiguous service is received from a terminal during a mid-point of a video stream. A delay time that may be generated when the video contents are transmitted is estimated for each of a patching type and a fast broadcasting type. A transmission type with a shorter delay time for the video contents is determined based on the estimated delay time for each of the patching type and the fast broadcasting type. And the video contents are transmitted to the terminal by applying the determined transmission type.

### CROSS-REFERENCE TO RELATED APPLICATION(S) AND CLAIM OF PRIORITY

The present application claims the benefit under 35 U.S.C. §119(a) of a Korean patent application filed in the Korean Intellectual Property Office on Apr. 20, 2010 and assigned Serial No. 2010-0036400, the entire disclosure of which is hereby incorporated by reference.

### TECHNICAL FIELD OF THE INVENTION

The present invention relates to an apparatus and method for video transmission in a communication system. In particular, the present invention relates to an apparatus and method for effective video transmission in a communication system for supporting an Internet Protocol Television (IPTV) service between heterogeneous networks.

### BACKGROUND OF THE INVENTION

With the widespread use of broadband media and improvement in communication speed, the Internet has recently emerged as a new medium which enables a one-source multi-service. As an example of the one-source multi-service, multimedia contents provided by an Internet service provider are provided using a broadcasting service through the Internet in addition to a plurality of public television channels and radio channels. Furthermore, demands on Internet broadcasting for providing the one-source multi-service are being increased along with the rapid increase in the population of Internet users.

An Internet Protocol Television (IPTV) based on Internet Protocol (IP) is an example of a representative service introduced in such a situation. The IPTV is a good example because various multimedia services desired by a user are provided interactively through the high-speed Internet.

The IPTV provides a multimedia service by using a Video on Demand (VoD) technique. The VoD technique may be roughly classified into True-VoD (TVoD) and Near-VoD (NVoD) when it is classified according to a video transmission type.

TVoD is a method in which a viewer may select and watch desired video at a desired time, and is an interactive service type for providing various multimedia services to the viewer through one dedicated channel. Although the interactive service is a merit of the TVoD, the TVoD has a disadvantage in that a large bandwidth is required to provide a service because the viewer occupies a transmission channel from a VoD server to a viewer side, and thus system costs are high.

In contrast, NVoD is a method in which one video is broadcast with a specific interval through several channels while not considering an interactive service and a waiting time of the viewer. NVoD has an advantage in that system costs may be significantly decreased because a plurality of viewers may watch video simultaneously by using one channel. NVoD requires a significantly smaller number of channels than TVoD, but has a disadvantage in that many viewers may not immediately see video that they requested. However, a viewer's request on the VoD is intensively generated for specific video, and also a viewer's request time is intensively generated at a specific time band. For this reason, in popular video, the use of the NVoD is advantageous over the use of the TVoD in terms of a bandwidth.

Recently, many researches are ongoing to improve performance of the NVoD, and such researches are classified into a patching type and a broadcasting type.

The patching type is configured in such a manner that video data is repetitively transmitted with a specific time interval and a channel is added during a transmission period time of the video data. That is, the patching type is a method in which a regular channel is generated for an initial request, a user is dynamically subscribed to the regular channel at a later request, and a previous part is transmitted through a patching channel. The patching type does not have an initial delay time, and requires a storage space for buffering on the viewer's side. In addition, the patching type defines a maximum time interval in which a new request may be associated with an old regular channel as a patching window size, and generates a new regular channel when a request time is beyond the pre-defined patching window size.

In contrast, the broadcasting type is a method in which video data is divided by using several methods according to a bandwidth and a length and the data is periodically transmitted to different channels. Examples of the NVoD based on the broadcasting type include fast broadcasting, harmonic broadcasting, staircase broadcasting, pyramid broadcasting, skyscraper broadcasting, pagoda broadcasting, and such. Among them, the fast broadcasting type is a method in which video data is divided into N segments, each including the same size in a time axis, and is transmitted by being distributed through each logical channel at a channel bandwidth of b[bps]. Through an i^{th} logical channel, a (2ⁱ⁻¹)^{th} segment to a (2ⁱ-1)^{th} segment are repetitively transmitted in sequence among the N divided segments. When the number of available channels is I, the total number N of segments is 2^{I}-1. A system determines the number of logical channels based on the number of segments.

Recently, as a combined wired/wireless IPTV has gained attention, there is a demand for a method that ensures service continuity such that a service which is received through a wired network may be continuously received through a wireless network. For example, a user who watches video through a wired set-top box may intend to watch the same video seamlessly through a mobile terminal. The conventional patching type and fast broadcasting type may ensure continuous and effective playback under the assumption that the user requests a service from the start point of the video. If the user requests a continuous service from the mid-point of the video, a delay time is generated and thus it may be difficult to ensure service continuity.

### SUMMARY OF THE INVENTION

To address the above-discussed deficiencies of the prior art, a primary aspect of the present invention is to solve at least the above-mentioned problems and/or disadvantages and to provide at least the advantages described below. Accordingly, an aspect of the present invention is to provide an apparatus and method for effective video transmission in a communication system for supporting an Internet Protocol Television (IPTV) service between heterogeneous networks.

Another aspect of the present invention is to provide an apparatus and method for effective video transmission capable of ensuring service continuity by effectively decreasing a delay time that may be generated when a user requests a continuous service in a communication system for supporting an IPTV service between heterogeneous networks.

Another aspect of the present invention is provide an apparatus and method for determining a delay time that may be generated when video is transmitted in each of a patching type and a fast broadcasting type and for transmitting video by selecting a video transmission type that requites a shorter delay time.

In accordance with an aspect of the present invention, a method for transmitting video contents by a server in a communication system is provided. A request for a contiguous service is received from a terminal during a mid-point of a video stream. A delay time that may be generated when the video contents are transmitted is estimated for each of a patching type and a fast broadcasting type. A transmission type with a shorter delay time for the video contents is determined based on the estimated delay time for each of the patching type and the fast broadcasting type. And the video contents are transmitted to the terminal by applying the determined transmission type.

In accordance with another aspect of the present invention, an apparatus for transmitting video contents by a server in a communication system is provided. The apparatus includes a service request receiver, a delay time determination unit, a transmission type determination unit, and a transmitter. The service request receiver receives a request from a terminal for a contiguous service during a mid-point of a video stream. The delay time determination unit estimates a delay time that may be generated when the video contents are transmitted for each of a patching type and a fast broadcasting type. The transmission type determination unit determines a transmission type with a shorter delay time for the video contents based on the estimated delay time for each of the patching type and the fast broadcasting type. And the transmitter transmits the video contents to the terminal by applying the determined transmission type.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating of a communication system for supporting an IPTV service between heterogeneous networks and a structure of a Video on Demand (VoD) server according to an embodiment of the present invention;

FIG. 2 illustrates an example of a video transmission method of a VoD server in a communication system for supporting an Internet Protocol Television (IPTV) service between heterogeneous networks according to an embodiment of the present invention; and

FIG. 3 illustrates a process for video transmission of a VoD server in a communication system for supporting an IPTV service between heterogeneous networks according to an embodiment of the present invention.

### DETAILED DESCRIPTION OF THE INVENTION

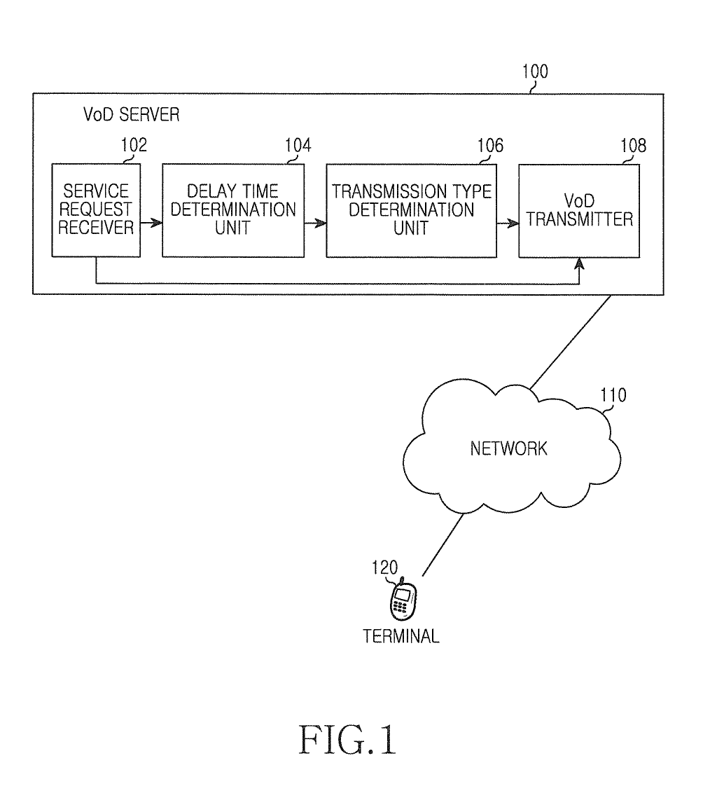

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The present invention described hereinafter relates to a method for effective video transmission in a communication system for supporting an Internet Protocol Television (IPTV) service between heterogeneous networks.

FIG. 1 is a block diagram illustrating of a communication system for supporting an IPTV service between heterogeneous networks and a structure of a Video on Demand (VoD) server according to an embodiment of the present invention.

Referring to FIG. 1, the communication system for supporting the IPTV service between the heterogeneous networks includes a VoD server 100, a network 110, and a terminal 120. The VoD server 100 includes a service request receiver 102, a delay time determination unit 104, a transmission type determination unit 106, and a VoD transmitter 108.

The VoD server 100 receives a request for VoD contents from the terminal 120, and transmits the VoD contents to the terminal 120 through the network 110 according to the request. In addition to a typical function, according to the present invention, if a contiguous service is requested from the mid-point of the VoD stream from the terminal 120, the VoD server 100 determines a delay time that may be generated when the VoD stream is transmitted in each of a patching type and a fast broadcasting type and transmits the VoD stream from the mid-point thereof by selecting a transmission type with a shorter delay time. The term “mid-point” refers to any point between a start point and an end point.

In an embodiment, the service request receiver 102 of the VoD server 100 receives a service request for VoD contents from the terminal 120, searches a database (not shown) to find the VoD contents corresponding to the received service request, and provides the found VoD contents to the VoD transmitter 108. If the service request received from the terminal 120 requests a continuous service from the mid-point of the VoD stream, the service request receiver 102 searches the database (not shown) to find the VoD contents corresponding to the received service request and provides the found VoD contents to the delay time determination unit 104.

For the VoD contents provided from the service request receiver 102, the delay time determination unit 104 determines the delay time that may be generated when the VoD stream is transmitted in each of the patching type and the fast broadcasting type, and provides the possible delay time determined for each of the patching type and the fast broadcasting type to the transmission type determination unit 106.

The transmission type determination unit 106 determines a transmission type with a shorter delay time for the VoD contents based on possible delay time determined for each of the patching type and the fast broadcasting type and provided from the delay time determination unit 104, and provides the determined type to the VoD transmitter 108.

The VoD transmitter 108 transmits the VoD contents to the terminal 120 according to the transmission type (i.e., the patching type or the fast broadcasting type) determined by the transmission type determination unit 106.

The network 110 is an IP-based network for providing an IPTV service, and provides the VoD contents from the VoD server 100 to the terminal 120.

The terminal 120 requests the VoD server 100 to send the VoD contents according to a user's request, and thus plays back the VoD contents received from the VoD server 100 through the network 110. According to an embodiment, the terminal 120 may request the VoD server 100 to send a continuous service from the mid-point of the VoD stream according to the user's request. Therefore, the terminal 120 may receive and play back the VoD stream from the mid-point from the VoD server 100. In this situation, the terminal 120 receives the VoD stream according to the transmission type with the short delay time between the patching type and the fast broadcasting type. According to an embodiment, the terminal 120 may be one of a television set, a monitor, and a personal digital assistant.

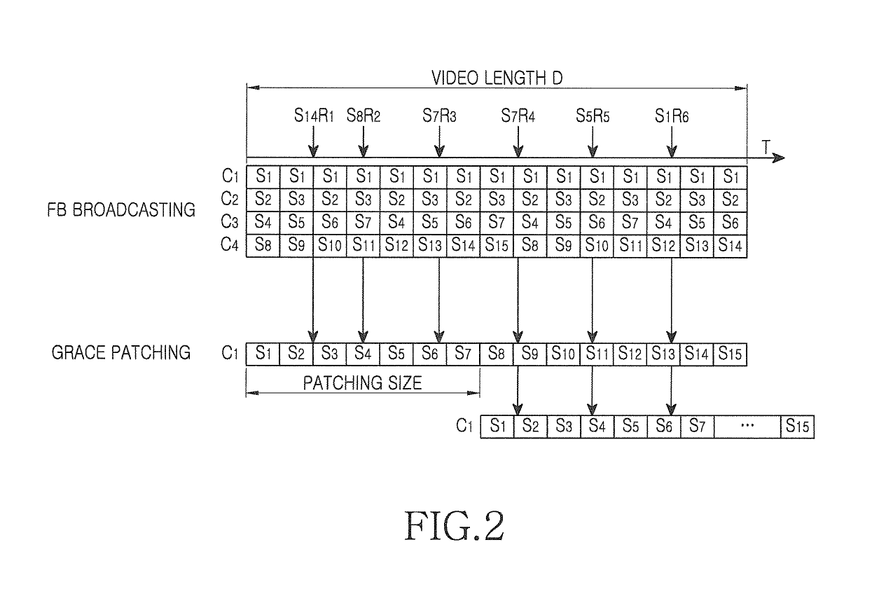

FIG. 2 illustrates an example of a video transmission method of a VoD server in a communication system for supporting an IPTV service between heterogeneous networks according to an embodiment of the present invention.

Referring to FIG. 2, D denotes a length of a VoD stream, Sᵢ denotes a segment index corresponding to a mid-point segment (i.e. after the first segment) of the VoD stream requested by a terminal through a service request, and Rⱼ denotes an index of the terminal that requests a continuous service from the mid-point of the VoD stream. That is, Sᵢ Rⱼ denotes an i^{th} segment corresponding to the mid-point of the VoD stream requested through the service request by a j^{th} terminal that requests the continuous service from the mid-point of the VoD stream.

When using the fast broadcasting type, the VoD stream is divided into N (e.g., ‘15’) segments each including the same length in a time axis. Then, through a first logical channel, a (2¹⁻¹)^{th} (i.e., 1^{st}) segment to a (2¹-1)^{th} (i.e., 1^{st}) segment are repetitively transmitted in sequence among the fifteen divided segments. Through a second logical channel, a 2^{nd} (i.e., (2²⁻¹)^{th}) segment to a 3^{rd} (i.e., (2²-1)^{th}) segment are repetitively transmitted in sequence among the fifteen divided segments. Through a third logical channel, a 4^{th} (i.e., (2³⁻¹)^{th})) segment to a 7^{th} (i.e., (2³-1)^{th}) segment are repetitively transmitted in sequence among the fifteen divided segments. Through a fourth logical channel, an 8^{th} (i.e., (2⁴⁻¹)^{th}) segment to a 15^{th} (i.e., (2⁴-1)^{th}) segment are repetitively transmitted in sequence among the fifteen divided segments.

When using the patching type, the VoD stream is divided into N (e.g., ‘15’) segments each including the same length in the time axis, and the fifteen divided segments are sequentially transmitted through a regular channel. In the patching type, a maximum time interval in which a service request may be associated with an old regular channel is defined as a patching window size, and a new regular channel is generated when a time at which the service request is received from a terminal is not within the pre-defined patching window size. In addition, in the patching type, when the service request is associated with the old regular channel, a previous stream part is transmitted to the terminal through a patching channel. According to an embodiment, the patching window size is defined as (VoD stream length/2), and thus it is assumed that the regular channel is generated with a period of (VoD stream length/2).

For S₁₄ R₁, the delay time that may be generated when the VoD stream is transmitted in the fast broadcasting type is in the range of S₁₀ to S₁₃ in the fourth logical channel which transmits 14^{th} segment, and the delay time that may be generated when the VoD stream is transmitted in the patching type is in the range of S₃ to S₁₃. Therefore, in S₁₄ R₁, a VoD server transmits the VoD stream to the terminal by applying the fast broadcasting type with a relatively short delay time.

For S₈ R₂, the VoD server receives the service request from the terminal from the mid-point of a segment rather than from the start point of the segment. Therefore, the delay time that may be generated when the VoD stream is transmitted in the fast broadcasting type is in the range of up to S₁₁ to S₁₅, and the delay time that may be generated when the VoD stream is transmitted in the patching type is in the range of up to S₄ to S₇. Therefore, in S₈ R₂, the VoD server transmits the VoD stream to the terminal by applying the patching type with a relatively short delay time.

For S₇ R₃, the VoD server receives the service request from the terminal from the mid-point of a segment rather than from the start point of the segment. Therefore, the delay time that may be generated when the VoD stream is transmitted in the fast broadcasting type is in the range of up to S₅ to S₆, and the delay time that may be generated when the VoD stream is transmitted in the patching type is in the range of up to S₆. Therefore, in S₇ R₃, the VoD server transmits the VoD stream to the terminal by applying the patching type with a relatively short delay time.

For S₅ R₅, the VoD server receives the service request from the terminal from the mid-point of a segment rather than from the start point of the segment. Therefore, the delay time that may be generated when the VoD stream is transmitted in the fast broadcasting type is a time corresponding to up to three segments (i.e., S₆, S₇, and S₄). In contrast, when using the patching type, a regular channel is generated with a period of (VoD stream length/2). Therefore, the delay time that may be generated when the VoD stream is transmitted in the patching type is a time corresponding to up to one segment (i.e., S₄). Therefore, in S₅ R₅, the VoD server transmits the VoD stream to the terminal by applying the patching type with a relatively short delay time.

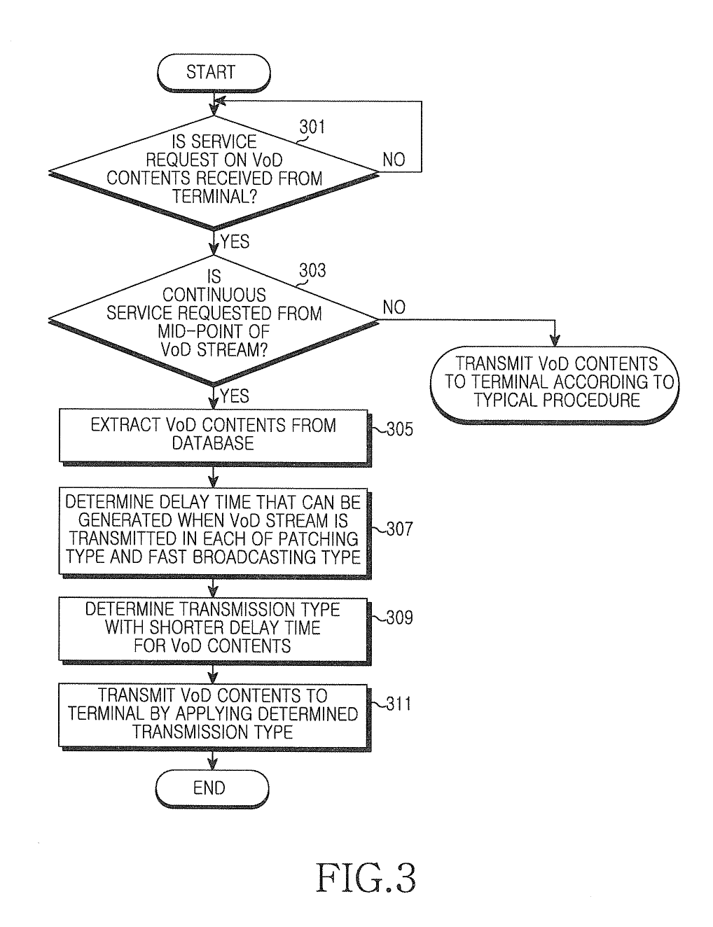

FIG. 3 illustrates a process for video transmission of a VoD server in a communication system for supporting an IPTV service between heterogeneous networks according to an embodiment of the present invention.

Referring to FIG. 3, the VoD server determines whether a service request on VoD contents is received from a terminal in step 301.

If it is determined in step 301 that the service request on the VoD contents is received from the terminal, proceeding to step 303, the VoD server determines whether the received service request is a request for a continuous service from the mid-point of the VoD stream.

If it is determined in step 303 that the received service request is the request for the continuous service from the start point of the VoD stream, the VoD server extracts the VoD contents from a database according to a typical procedure and transmits the VoD contents to the terminal.

Otherwise, if it is determined in step 303 that the received service request is the request for the continuous service from the mid-point of the VoD stream, proceeding to step 305, the VoD server extracts the VoD contents corresponding to the received service request from the database.

In step 307, with respect to the extracted VoD contents, the VoD server determines a delay time that may be generated when the VoD stream is transmitted in each of a patching type and a fast broadcasting type.

To determine the delay time that may be generated when the VoD stream is transmitted in the fast broadcasting type, the VoD server compares a time at which the service request is received from the terminal and the point of the VoD stream requested by the terminal through the service request, determines whether the time of receiving the service request from the terminal is a segment start point, and determines the delay time according to the comparison and determination result.

That is, if the time at which the service request is received from the terminal is prior to the point of the VoD stream requested by the terminal through the service request, and if the time of receiving the service request from the terminal is not the segment start point, the VoD server determines the delay time that may be generated when the VoD stream is transmitted in the fast broadcasting type, by using Equation 1 below.

$${W}_{b}^{C} ( t ) = d ( S mod {2}^{{C}_{i} - 1} - ⌊ \frac{t}{d} ⌋ mod {2}^{{c}_{i} - 1} ) + ( d - ( t mod d ) ) \qquad [ Eqn . 1 ]$$

It is assumed herein that, when using the fast broadcasting type, the VoD stream is divided into N segments each including the same length in a time axis, and through an i^{th} logical channel, a (2ⁱ⁻¹)^{th} segment to a (2ⁱ-1)^{th} segment are repetitively transmitted in sequence among the N divided segments. In this situation, d denotes a video stream length, and S denotes a segment index corresponding to the mid-point of the VoD stream requested by the terminal through the service request. Cᵢ denotes a logical channel index corresponding to the mid-point of the VoD stream requested by the terminal through the service request, and t denotes a length of the VoD stream corresponding to a time between the start point of the VoD stream and the time at which the service request is received from the terminal.

In addition, if the time of receiving the service request from the terminal is prior to the point of the VoD stream requested by the terminal through the service request and if the time of receiving the service request from the terminal is the segment start point, the VoD server determines the delay time that may be generated when the VoD stream is transmitted in the fast broadcasting type, by using Equation 2 below.

$${W}_{b}^{C} ( t ) = d ( S mod {2}^{{C}_{i} - 1} - ⌊ \frac{t}{d} ⌋ mod {2}^{{C}_{i} - 1} ) \qquad [ Eqn . 2 ]$$

If the time of receiving the service request from the terminal is later than the point of the VoD stream requested by the terminal through the service request, irrespective of whether the time of receiving the service request from the terminal is the segment start point or not, the VoD server determines the delay time that may be generated when the VoD stream is transmitted in the fast broadcasting type, by using Equation 3 below.

$${W}_{b}^{C} ( t ) = d ( S mod {2}^{{C}_{i} - 1} + ( {2}^{{C}_{i} - 1} - ⌊ \frac{t}{d} ⌋ mod {2}^{{C}_{i} - 1} ) ) \qquad [ Eqn . 3 ]$$

To determine the delay time that may be generated when the VoD stream is transmitted in the patching type, the VoD server compares the time of receiving the service request from the terminal and a patching window, determines whether the time of receiving the service request from the terminal is the segment start point, and determines the delay time by using a different method according to the comparison and determination result.

That is, if the time at which the service request is received from the terminal is within the patching window size, irrespective of whether the time of receiving the service request from the terminal is the segment start point or not, the VoD server determines the delay time that may be generated when the VoD stream is transmitted in the patching type, by using Equation 4 below.

Wₚ^{c}(t)=0 [Eqn. 4]

In the patching type, a maximum time interval in which a service request may be associated with an old regular channel is defined as a patching window size, and a new regular channel is generated when the time of receiving the service request from the terminal is not within the pre-defined patching window size. In addition, in the patching type, when the service request is associated with the old regular channel, a previous stream part is transmitted to the terminal through a patching channel. Therefore, if the time of receiving the service request from the terminal is within the patching window size, the previous stream part may be transmitted through the patching channel, and thus the delay time that may be generated when the VoD stream is transmitted in the patching type may be determined to be zero by using Equation 4 above.

In addition, if the time of receiving the service request from the terminal is not within the patching window size, and if the time of receiving the service request from the terminal is not the segment start point, the VoD server determines the delay time that may be generated when the VoD stream is transmitted in the patching type, by using Equation 5 below.

$${W}_{p}^{C} ( t ) = d ( S - ⌊ \frac{t}{d} ⌋ mod T ) + ( d - ( t mod d ) ) \qquad [ Eqn . 5 ]$$

It is assumed herein that, when using the patching type, the VoD stream is divided into N segments each including the same length in a time axis, and the N divided segments are sequentially transmitted through a regular channel. In this situation, d denotes a video stream length, and S denotes a segment index corresponding to the mid-point of the VoD stream requested by the terminal through the service request. t denotes a length of the VoD stream corresponding to a time between the start point of the VoD stream and the time at which the service request is received from the terminal. T denotes a patching window size, and may be defined, for example, as (VoD stream length/2). In the patching type, if the time of receiving the service request from the terminal is not within the patching window size, a new regular channel is generated at the time of receiving the service request from the terminal. Therefore, if the time of receiving the service request from the terminal is not within the patching window size, as described in Equation 5 above, the delay time that may be generated when the VoD stream is transmitted in the patching type may be determined as a time between a time of generating the new regular channel (i.e., the time of receiving the service request from the terminal) and the mid-point of the VoD stream requested by the terminal through the service request.

If the time of receiving the service request from the terminal is not within the patching window size and if the time of receiving the service request from the terminal is the segment start point, the VoD server determines the delay time that may be generated when the VoD stream is transmitted in the patching type, by using Equation 6 below.

$${W}_{p}^{C} ( t ) = d ( S - ⌊ \frac{t}{d} ⌋ mod T ) \qquad [ Eqn . 6 ]$$

In step 309, the VoD server determines a transmission type with a shorter delay time for the VoD contents based on the possible delay time determined for each of the patching type and the fast broadcasting type.

In the patching type, if a first service request on the VoD contents is received after a time corresponding to the pre-defined patching window size, the new multicast regular channel is generated. If the total number of multicast regular channels allocated to the patching type is greater than or equal to the total number of multicast regular channels required by the service request reception, the VoD contents may be transmitted in the patching type when the service request is received. However, if the total number of multicast regular channels allocated to the patching type is less than the total number of multicast regular channels required by the service request reception, the VoD contents may not be transmitted in the patching type when the service request is received. Therefore, if the total number of multicast regular channels allocated to the patching type is less than the total number of multicast regular channels required by the service request reception, even if it is determined that the patching type requires a shorter delay time than the fast broadcasting type, the fast broadcasting type is determined as the transmission type for the VoD contents.

The total number of multicast regular channels required by the service request reception may be determined by using Equation 7 below.

$$\begin{matrix}{K}_{m} = ⌈ {\sum }_{i = 1}^{M} \frac{D}{T + {λ}_{i}^{- 1}} ⌉ \\ = ⌈ {\sum }_{i = 1}^{M} \frac{2 D}{D + 2 / {λ}_{i}} ⌉\end{matrix} \qquad [ Eqn . 7 ]$$

M denotes the total number of VoDs, and T denotes a patching window size. D denotes a VoD stream length, and λᵢ denotes a total service request rate of an i^{th} VoD.

In step 311, the VoD server transmits the extracted VoD contents to the terminal by applying the determined transmission type (i.e., the patching type or the fast broadcasting type).

Thereafter, the process of FIG. 3 ends.

According to embodiments of the present invention, when a user requests a contiguous service in a communication system for supporting an IPTV service between heterogeneous networks, a delay time that may be generated when video is transmitted in each of a patching type and a fast broadcasting type is determined, and the video is transmitted by selecting a transmission type with a shorter delay time. Therefore, when the user requests the continuous service, a possible delay time may be effectively reduced and thus service continuity may be ensured. In addition, limited resources of a VoD server may be effectively utilized.

Although the present disclosure has been described with an embodiment, various changes and modifications may be suggested to one skilled in the art. It is intended that the present disclosure encompass such changes and modifications as fall within the scope of the appended claims.

What is claimed is:

1. A method for transmitting video contents by a server in a communication system, the method comprising:
receiving a request for a contiguous service during a mid-point of a video stream from a terminal;
estimating a delay time that may be generated when the video contents are transmitted for each of a patching type and a fast broadcasting type;
determining a transmission type with a shorter delay time for the video contents based on the estimated delay time for each of the patching type and the fast broadcasting type; and
transmitting the video contents to the terminal by applying the determined transmission type.

2. The method of claim 1, wherein the communication system supports an Internet Protocol Television (IPTV) service between heterogeneous networks.

3. The method of claim 1, wherein estimating the delay time for the fast broadcasting type comprises:
comparing a time of receiving the service request from the terminal and point of the video stream requested by the terminal through the service request, determining whether the time of receiving the service request from the terminal is a segment start point, and estimating the delay time that may be generated when the video contents are transmitted in the fast broadcasting type, and
wherein estimating the delay time for the patching type comprises:
comparing the time of receiving the service request from the terminal and a patching window, determining whether the time of receiving the service request from the terminal is the segment start point, and estimating the delay time that may be generated when the video contents are transmitted in the patching type.

4. The method of claim 3, wherein when the time of receiving the service request from the terminal is prior to the point of the video stream requested by the terminal through the service request and the time of receiving the service request from the terminal is not the segment start point, the delay time that may be generated when the video contents are transmitted in the fast broadcasting type is estimated according to the following equation:
$${W}_{b}^{C} ( t ) = d ( S mod {2}^{{C}_{i} - 1} - ⌊ \frac{t}{d} ⌋ mod {2}^{{C}_{i} - 1} ) + ( d - ( t mod d ) ) ,$$
wherein d denotes a video stream length, S denotes a segment index corresponding to a mid-point segment of the video stream requested by the terminal through the service request, Cᵢ denotes a logical channel index corresponding to the mid-point segment of the video stream requested by the terminal through the service request, and t denotes a length of the video stream corresponding to a time between a start point of the video stream and the time of receiving the service request from the terminal, wherein it is assumed that, when using the fast broadcasting type, the video stream is divided into N segments each comprising the same length in a time axis, and through an i^{th} logical channel, a (2ⁱ⁻¹)^{th} segment to a (2ⁱ-1)^{th} segment are repetitively transmitted in sequence among the N divided segments.

5. The method of claim 3, wherein when the time of receiving the service request from the terminal is prior to the point of the video stream requested by the terminal through the service request and the time of receiving the service request from the terminal is the segment start point, the delay time that may be generated when the video contents are transmitted in the fast broadcasting type is estimated according to the following equation:
$${W}_{b}^{C} ( t ) = d ( S mod {2}^{{C}_{i} - 1} - ⌊ \frac{t}{d} ⌋ mod {2}^{{C}_{i} - 1} ) ,$$
wherein d denotes a video stream length, S denotes a segment index corresponding to a mid-point segment of the video stream requested by the terminal through the service request, Cᵢ denotes a logical channel index corresponding to the mid-point segment of the video stream requested by the terminal through the service request, and t denotes a length of the video stream corresponding to a time between a start point of the video stream and the time of receiving the service request from the terminal, wherein it is assumed that, when using the fast broadcasting type, the video stream is divided into N segments each comprising the same length in a time axis, and through an i^{th} logical channel, a (2ⁱ⁻¹)^{th} segment to a (2ⁱ-1)^{th} segment are repetitively transmitted in sequence among the N divided segments.

6. The method of claim 3, wherein when the time of receiving the service request from the terminal is later than the point of the video stream requested by the terminal through the service request, the delay time that may be generated when the video contents are transmitted in the fast broadcasting type is estimated according to the following equation:
$${W}_{b}^{C} ( t ) = d ( S mod {2}^{{C}_{i} - 1} + ( {2}^{{c}_{i} - 1} - ⌊ \frac{t}{d} ⌋ mod {2}^{{C}_{i} - 1} ) ) ,$$
wherein d denotes a video stream length, S denotes a segment index corresponding to a mid-point segment of the video stream requested by the terminal through the service request, Cᵢ denotes a logical channel index corresponding to the mid-point segment of the video stream requested by the terminal through the service request, and t denotes a length of the video stream corresponding to a time between a start point of the video stream and the time of receiving the service request from the terminal, wherein it is assumed that, when using the fast broadcasting type, the video stream is divided into N segments each comprising the same length in a time axis, and through an i^{th} logical channel, a (2ⁱ⁻¹)^{th} segment to a (2ⁱ-1)^{th} segment are repetitively transmitted in sequence among the N divided segments.

7. The method of claim 3, wherein when the time of receiving the service request from the terminal is within the patching window, the delay time that may be generated when the video contents are transmitted in the patching type is estimated according to the following equation: Wₚ^{c}(t)=0.

8. The method of claim 3, wherein when the time of receiving the service request from the terminal is not within the patching window and the time of receiving the service request from the terminal is not the segment start point, the delay time that may be generated when the video contents are transmitted in the patching type is estimated according to the following equation:
$${W}_{p}^{C} ( t ) = d ( S - ⌊ \frac{t}{d} ⌋ mod T ) + ( d - ( t mod d ) ) ,$$
wherein d denotes a video stream length, S denotes a segment index corresponding to a mid-point segment of the video stream requested by the terminal through the service request, t denotes a length of the video stream corresponding to a time between a start point of the video stream and the time of receiving the service request from the terminal, and T denotes a patching window size.

9. The method of claim 3, wherein when the time of receiving the service request from the terminal is not within the patching window and the time of receiving the service request from the terminal is the segment start point, the delay time that may be generated when the video contents are transmitted in the patching type is estimated according to the following equation:
$${W}_{p}^{C} ( t ) = d ( S - ⌊ \frac{t}{d} ⌋ mod T ) ) ,$$
wherein d denotes a video stream length, S denotes a segment index corresponding to a mid-point segment of the video stream requested by the terminal through the service request, t denotes a length of the video stream corresponding to a time between a start point of the video stream and the time of receiving the service request from the terminal, and T denotes a patching window size.

10. The method of claim 1, further comprising:
when the determined transmission type is the patching type, determining whether a total number of multicast regular channels allocated to the patching type is less than a total number of multicast regular channels required by service request reception; and
when the total number of multicast regular channels allocated to the patching type is less than the total number of multicast regular channels required by service request reception, changing the determine transmission type to the fast broadcasting type.

11. The method of claim 10, wherein the total number of multicast regular channels required by the service request reception is determined according to the following equation:
$$\begin{matrix}{K}_{m} = ⌈ {\sum }_{i = 1}^{M} \frac{D}{T + {λ}_{i}^{- 1}} ⌉ \\ = ⌈ {\sum }_{i = 1}^{M} \frac{2 D}{D + 2 / {λ}_{i}} ⌉ ,\end{matrix}$$
wherein M denotes a total number of videos, T denotes a patching window size, D denotes a video stream length, and λᵢ denotes a total service request rate of an i^{th} video.

12. An apparatus for transmitting video contents by a server in a communication system, the apparatus comprising:
a service request receiver configured to receive a request for a contiguous service during a mid-point of a video stream from a terminal;
a delay time determination unit configured to estimate a delay time that may be generated when the video contents are transmitted for each of a patching type and a fast broadcasting type;
a transmission type determination unit configured to determine a transmission type with a shorter delay time for the video contents based on the estimated delay time for each of the patching type and the fast broadcasting type; and
a transmitter configured to transmit the video contents to the terminal by applying the determined transmission type.

13. The apparatus of claim 12, wherein the communication system supports an Internet Protocol Television (IPTV) service between heterogeneous networks.

14. The apparatus of claim 12, wherein the delay time determination unit is further configured to:
when estimating the delay time for the fast broadcasting type: compare a time of receiving the service request from the terminal and point of the video stream requested by the terminal through the service request, determine whether the time of receiving the service request from the terminal is a segment start point, and estimate the delay time that may be generated when the video contents are transmitted in the fast broadcasting type; and
when estimating the delay time for the patching type: compare the time of receiving the service request from the terminal and a patching window, determine whether the time of receiving the service request from the terminal is the segment start point, and estimate the delay time that may be generated when the video contents are transmitted in the patching type.

15. The apparatus of claim 14, wherein when the time of receiving the service request from the terminal is prior to the point of the video stream requested by the terminal through the service request and the time of receiving the service request from the terminal is not the segment start point, the delay time determination unit is further configured to estimate the delay time that may be generated when the video contents are transmitted in the fast broadcasting type according to the following equation:
$${W}_{b}^{C} ( t ) = d ( S mod {2}^{{C}_{i} - 1} - ⌊ \frac{t}{d} ⌋ mod {2}^{{C}_{i} - 1} ) + ( d - ( t mod d ) ) ,$$
wherein d denotes a video stream length, S denotes a segment index corresponding to a mid-point segment of the video stream requested by the terminal through the service request, Cᵢ denotes a logical channel index corresponding to the mid-point segment of the video stream requested by the terminal through the service request, and t denotes a length of the video stream corresponding to a time between a start point of the video stream and the time of receiving the service request from the terminal, wherein it is assumed that, when using the fast broadcasting type, the video stream is divided into N segments each comprising the same length in a time axis, and through an i^{th} logical channel, a (2ⁱ⁻¹)^{th} segment to a (2ⁱ-1)^{th} segment are repetitively transmitted in sequence among the N divided segments.

16. The apparatus of claim 14, wherein when the time of receiving the service request from the terminal is prior to the point of the video stream requested by the terminal through the service request and the time of receiving the service request from the terminal is the segment start point, the delay time determination unit is further configured to estimate the delay time that may be generated when the video contents are transmitted in the fast broadcasting type according to the following equation:
$${W}_{b}^{C} ( t ) = d ( S mod {2}^{{C}_{i} - 1} - ⌊ \frac{t}{d} ⌋ mod {2}^{{C}_{i} - 1} ) ,$$
wherein d denotes a video stream length, S denotes a segment index corresponding to a mid-point segment of the video stream requested by the terminal through the service request, Cᵢ denotes a logical channel index corresponding to the mid-point segment of the video stream requested by the terminal through the service request, and t denotes a length of the video stream corresponding to a time between a start point of the video stream and the time of receiving the service request from the terminal, wherein it is assumed that, when using the fast broadcasting type, the video stream is divided into N segments each comprising the same length in a time axis, and through an i^{th} logical channel, a (2ⁱ⁻¹)^{th} segment to a (2ⁱ-1)^{th} segment are repetitively transmitted in sequence among the N divided segments.

17. The apparatus of claim 14, wherein when the time of receiving the service request from the terminal is later than the point of the video stream requested by the terminal through the service request, the delay time determination unit is further configured to estimate the delay time that may be generated when the video contents are transmitted in the fast broadcasting type according to the following equation:
$${W}_{b}^{C} ( t ) = d ( S mod {2}^{{C}_{i} - 1} + ( {2}^{{C}_{i} - 1} - ⌊ \frac{t}{d} ⌋ mod {2}^{{C}_{i} - 1} ) ) ,$$
wherein d denotes a video stream length, S denotes a segment index corresponding to a mid-point segment of the video stream requested by the terminal through the service request, Cᵢ denotes a logical channel index corresponding to the mid-point segment of the video stream requested by the terminal through the service request, and t denotes a length of the video stream corresponding to a time between a start point of the video stream and the time of receiving the service request from the terminal, wherein it is assumed that, when using the fast broadcasting type, the video stream is divided into N segments each comprising the same length in a time axis, and through an i^{th} logical channel, a (2ⁱ⁻¹)^{th} segment to a (2ⁱ-1)^{th} segment are repetitively transmitted in sequence among the N divided segments.

18. The apparatus of claim 14, wherein when the time of receiving the service request from the terminal is within the patching window, the delay time determination unit is further configured to estimate the delay time that may be generated when the video contents are transmitted in the patching type according to the following equation: Wₚ^{c}(t)=0.

19. The apparatus of claim 14, wherein when the time of receiving the service request from the terminal is not within the patching window and the time of receiving the service request from the terminal is not the segment start point, the delay time determination unit is further configured to estimate the delay time that may be generated when the video contents are transmitted in the patching type according to the following equation:
$${W}_{p}^{C} ( t ) = d ( S - ⌊ \frac{t}{d} ⌋ mod T ) + ( d - ( t mod d ) ) ,$$
wherein d denotes a video stream length, S denotes a segment index corresponding to a mid-point segment of the video stream requested by the terminal through the service request, t denotes a length of the video stream corresponding to a time between a start point of the video stream and the time of receiving the service request from the terminal, and T denotes a patching window size.

20. The apparatus of claim 14, wherein when the time of receiving the service request from the terminal is not within the patching window and the time of receiving the service request from the terminal is a segment start point, the delay time determination unit is further configured to estimate the delay time that may be generated when the video contents are transmitted in the patching type according to the following equation:
$${W}_{p}^{C} ( t ) = d ( S - ⌊ \frac{t}{d} ⌋ mod T ) ) ,$$
wherein d denotes a video stream length, S denotes a segment index corresponding to a mid-point segment of the video stream requested by the terminal through the service request, t denotes a length of the video stream corresponding to a time between a start point of the video stream and the time of receiving the service request from the terminal, and T denotes a patching window size.

21. The apparatus of claim 12, wherein the transmission type determination unit is further configured to:
determine whether a total number of multicast regular channels allocated to the patching type is less than a total number of multicast regular channels required by service request reception when the determined transmission type is the patching type, and
change the determine transmission type to the fast broadcasting type when the total number of multicast regular channels allocated to the patching type is less than the total number of multicast regular channels required by service request reception.

22. The apparatus of claim 21, wherein the transmission type determination unit is further configured to determine the total number of multicast regular channels required by the service request reception according to the following equation:
$$\begin{matrix}{K}_{m} = ⌈ {\sum }_{i = 1}^{M} \frac{D}{T + {λ}_{i}^{- 1}} ⌉ \\ = ⌈ {\sum }_{i = 1}^{M} \frac{2 D}{D + 2 / {λ}_{i}} ⌉ ,\end{matrix}$$
wherein M denotes a total number of videos, T denotes a patching window size, D denotes a video stream length, and λᵢ denotes a total service request rate of an i^{th} video.
